(19) United States
(12) Patent Application Publication
(10) Pub. No.: US 2025/0391911 A1
(43) Pub. Date: Dec. 25, 2025

(54) SLURRIES CONTAINING A SOLID ELECTROLYTE AND COMBINATION OF BINDERS AND METHODS OF MAKING THE SAME

(71) Applicant: Solid Power Operating, Inc., Louisville, CO (US)

(72) Inventors: Morgan MORRONI, Denver, CO (US); Clint R. Bickmore, Louisville, CO (US); Ian A. Morrissey, Boulder, CO (US); James Bergman, Arvada, CO (US)

(21) Appl. No.: 19/246,475

(22) Filed: Jun. 23, 2025

Related U.S. Application Data
(60) Provisional application No. 63/662,969, filed on Jun. 21, 2024.
(60) Provisional application No. 63/684,194, filed on Aug. 16, 2024.

(51) Int. Cl. H01M 10/056; H01M 4/137; H01M 4/60; H01M 50/446

(52) U.S. Cl. CPC H01M 10/056; H01M 4/137; H01M 4/60; H01M 50/446; H01M 2300/008

(57) ABSTRACT

Described herein are slurries comprising a solid electrolyte material, a hydrocarbon solvent, and a combination of binders, and methods of making the same. Additionally described are layers for electrochemical cells made from the slurries.

### CROSS-REFERENCE TO RELATED APPLICATIONS

This application is related to and claims priority under 35 U.S.C. § 119(e) from U.S. Provisional Application No. 63/684,194 filed Aug. 16, 2024, titled “Slurries Containing a Solid Electrolyte and Combination of Binders and Methods of Making the Same”, and U.S. Provisional Application No. 63/662,969 filed Jun. 21, 2024, titled “Slurries Containing a Solid Electrolyte and Combination of Binders and Methods of Making the Same”, the entire contents of each of which are incorporated by reference herein.

### FIELD OF THE DISCLOSURE

The present disclosure is directed toward methods of preparing slurries containing a solvent blend and binders. Therefore, the disclosure relates to the fields of batteries, including solid-state batteries, electronics, chemistry, and materials science.

### BACKGROUND

When making solid-state electrochemical cells, each layer of the cell is often formed as a slurry, coated on a substrate, and then dried. To achieve a homogenous slurry with the proper rheological properties to coat the slurry on a substrate, the choice of solvent may be important. The choice of solvent is even more important in slurries that contain solid electrolytes, as the solvent may degrade the solid electrolyte material. In certain cases, the slurry should be used immediately after the slurry is formed to prevent substantial degradation of the electrolyte.

What is needed are methods for preparing slurries containing a solid electrolyte material, wherein the slurry achieves the desired rheological properties for coating the slurry on a substrate and subsequently drying the mixture while not degrading the solid electrolyte material, among other possible advantages and improvements.

Further, there remains an unmet need for identifying successful electrode slurry mixtures and/or slurry conditions, wherein the electrode does not deteriorate or is unevenly coated. Optimizing for one or more scientific parameters (boiling point, vapor pressure, flash point, etc.) may not be possible on theory alone because the parameters are conflicting or otherwise inoperable in practice, resulting in a deteriorated electrode. Applicants have surprisingly identified unique electrode slurry mixtures and/or slurry conditions, wherein the electrode is evenly coated, does not deteriorate, and provides a superior electrolyte and superior electrode as compared to the prior art.

### SUMMARY

Provided herein are slurries for use in making electrochemical cell layers. The slurries include an ester solvent having Hansen Solubility Parameters following the formula: δ⁻²=(δD)²+(δP)²+(δH)², wherein δ is from about 16.4 MPa^{1/2} to about 18.2 MPa^{1/2}; δD is from about 15 MPa^{1/2} to about 18.2 MPa^{1/2}; δP is from greater than 4 MPa^{1/2} to about 6 MPa^{1/2}; and δH is from about 0 MPa^{1/2} to about 6 MPa^{1/2}, and wherein the ester solvent has the formula:

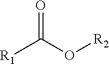

wherein R₁ is H, methyl, ethyl, or propyl, and R₂ is an acyclic linear or branched hydrocarbon chain having five carbon atoms or more; a hydrocarbon solvent; a low molecular weight binder having a molecular weight of 100,000 or less; and a high molecular weight binder having a molecular weight of 300,000 or more. In some embodiments, the slurries further include an alkali metal carboxylate material having the formula:

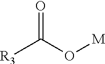

wherein R₃ comprises H, methyl, or ethyl, and wherein M comprises an alkali metal.

Further provided herein are electrochemical cells made using the slurries described herein. The electrochemical cells include a cathode layer comprising a cathode active material; a separator layer comprising a solid electrolyte material, a high molecular weight binder having a molecular weight of 300,000 or more, and a low molecular weight binder having a molecular weight of 100,000 or less, wherein the weight ratio of the high molecular weight binder to the low molecular weight binder is from about 10:90 to about 90:10; and an anode layer comprising an anode active material.

Further provided herein are slurries for use in making electrochemical cell layers. The slurries include an ester solvent, the ester solvent having the formula:

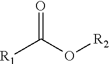

wherein R₁ is H, methyl, ethyl, or propyl, and R₂ is an acyclic linear or branched hydrocarbon chain having five carbon atoms or more; a hydrocarbon solvent; and a binder. In some embodiments, the slurries further include an alkali metal carboxylate material having the formula:

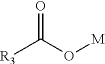

wherein R₃ comprises H, methyl, or ethyl, and wherein M comprises an alkali metal.

Further provided herein are electrochemical cell layers for use in making electrochemical cells and made using the slurries described herein. The electrochemical cell layers include a solid-state electrolyte material; a high molecular weight binder; and a low molecular weight binder.

### BRIEF DESCRIPTION OF THE FIGURES

The present disclosure may be understood by reference to the following detailed description taken in conjunction with the drawings briefly described below. It is noted that, for purposes of illustrative clarity, certain elements in the drawings may not be drawn to scale.

FIGS. 1A and 1B show example processes of the present disclosure for making solid-state electrodes.

FIG. 2 shows an apparatus for making solid-state electrochemical cell layers using the processes described herein.

### DETAILED DESCRIPTION

Before various aspects of the present invention are disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity and in another example, a numerical range of “about 50 mg/mL to about 80 mg/mL” should also be understood to provide support for the range of “50 mg/mL to 80 mg/mL.”

In this disclosure, the terms “including,” “containing,” and/or “having” are understood to mean comprising, and are open ended terms.

Described herein are slurries and methods for making slurries containing a solid electrolyte material for use in making an electrochemical cell, which in some cases may be considered a solid-state battery cell. The inventors surprisingly discovered that the use of particular solvent and binder combinations are especially effective at forming a slurry having desired rheological properties (e.g., tan (delta)) while not degrading the solid electrolyte. Surprisingly, the electrochemical cell layers made from the slurries described herein have exceptional toughness and elongation properties while maintaining a high ionic conductivity (e.g., 0.15 mS or more).

The slurry may comprise a hydrocarbon-based solvent, alone or in combination with one or more other solvents (e.g., an ester solvent). The hydrocarbon solvent may include xylene, toluene, benzene, hexane, heptane, octane, nonane, decane, isoparaffins, aromatics (e.g., A150ND, CAS No. 64742-94-5), or other hydrocarbon solvents known in the art and combinations thereof.

The slurry may comprise an ester solvent, alone or in combination with one or more other solvents (e.g., a hydrocarbon-based solvent). The ester solvent of the present disclosure may have the general formula of Formula (I):

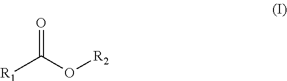

wherein R₁ comprises H or a hydrocarbon chain having one carbon atom (i.e., methyl or —CH₃) or two carbon atoms (i.e., ethyl or —CH₂CH₃), or three or more carbon atoms (i.e., propyl or isopropyl or —CH₂CH₂CH₃), and wherein R₂ comprises an acyclic hydrocarbon chain having five carbon atoms or more. In some embodiments, R₂ comprises an acyclic branched hydrocarbon chain having five carbon atoms or more, wherein the acyclic branched hydrocarbon chain comprises one or more branches having one or more carbon atoms. In some aspects, R₂ comprises an acyclic linear or branched hydrocarbon chain having five carbon atoms or more, six carbon atoms or more, seven carbon atoms or more, or eight carbon atoms or more. In some embodiments, R₂ comprises an acyclic linear or branched hydrocarbon chain having five carbon atoms up to twenty carbon atoms, or five carbon atoms up to 10 carbon atoms. In some embodiments, R₂ comprises an acyclic linear or branched hydrocarbon chain having five carbon atoms, six carbon atoms, seven carbon atoms, or eight carbon atoms.

In some embodiments, the slurry comprises one or more ester solvents of Formula (I) wherein R₁ comprises a hydrocarbon chain having one carbon atom (i.e., methyl or —CH₃). In some embodiments, the slurry comprises one or more ester solvents of Formula (I) wherein R₁ comprises a hydrocarbon chain having two carbon atoms (i.e., ethyl or —CH₂CH₃). In some embodiments, the slurry comprises one or more ester solvents of Formula (I) wherein R₁ comprises a hydrocarbon chain having three or more atoms (i.e., propyl or isopropyl or —CH₂CH₂CH₃).

In some embodiments, the slurry does not include an ester solvent of formula (I) wherein R₁ comprises a hydrocarbon chain having one carbon atom (i.e., methyl or —CH₃). In some embodiments, the slurry does not include an ester solvent of formula (I) wherein R₁ comprises a hydrocarbon chain having two carbon atoms (i.e., ethyl or —CH₂CH₃). In some embodiments, the slurry does not include an ester solvent of formula (I) wherein R₁ comprises a hydrocarbon chain having three or more atoms (i.e., propyl or isopropyl or —CH₂CH₂CH₃). In some embodiments, the slurry does not include an ester solvent of formula (I) wherein R₁ comprises a hydrocarbon chain having one carbon atom or three or more carbon atoms.

In some embodiments, the slurry comprises one or more ester solvents of formula (I) wherein R₂ comprises an acyclic hydrocarbon chain having five carbons atoms. In some embodiments, the slurry comprises one or more ester solvents of formula (I) wherein R₂ comprises an acyclic hydrocarbon chain having six carbon atoms. In some embodiments, the slurry comprises one or more ester solvents of formula (I) wherein R₂ comprises an acyclic hydrocarbon chain having seven carbon atoms. In some embodiments, the slurry comprises one or more ester solvents of formula (I) wherein R₂ comprises an acyclic hydrocarbon chain having eight carbon atoms. In some embodiments, the slurry comprises one or more ester solvents of formula (I) wherein R₂ comprises an acyclic hydrocarbon chain having nine carbon atoms. In some embodiments, the slurry comprises one or more ester solvents of formula (I) wherein R₂ comprises an acyclic hydrocarbon chain having ten carbon atoms.

In some embodiments, the slurry comprises one or more ester solvents of formula (I) wherein R₂ comprises an acyclic hydrocarbon chain having five or more carbons atoms. In some embodiments, the slurry comprises one or more ester solvents of formula (I) wherein R₂ comprises an acyclic hydrocarbon chain having six or more carbon atoms. In some embodiments, the slurry comprises one or more ester solvents of formula (I) wherein R₂ comprises an acyclic hydrocarbon chain having seven or more carbon atoms. In some embodiments, the slurry comprises one or more ester solvents of formula (I) wherein R₂ comprises an acyclic hydrocarbon chain having eight or more carbon atoms. In some embodiments, the slurry comprises one or more ester solvents of formula (I) wherein R₂ comprises an acyclic hydrocarbon chain having nine or more carbon atoms. In some embodiments, the slurry comprises one or more ester solvents of formula (I) wherein R₂ comprises an acyclic hydrocarbon chain having ten or more carbon atoms.

In some embodiments, the slurry does not include an ester solvent of formula (I) wherein R₂ comprises an acyclic hydrocarbon chain having four carbon atoms or less. In some embodiments, the slurry does not include an ester solvent of formula (I) wherein R₂ comprises an acyclic hydrocarbon chain having five carbon atoms or less. In some embodiments, the slurry does not include an ester solvent of formula (I) wherein R₂ comprises an acyclic hydrocarbon chain having six carbon atoms or less. In some embodiments, the slurry does not include an ester solvent of formula (I) wherein R₂ comprises an acyclic hydrocarbon chain having seven carbon atoms or less. In some embodiments, the slurry does not include an ester solvent of formula (I) wherein R₂ comprises an acyclic hydrocarbon chain having eight carbon atoms or less. In some embodiments, the slurry does not include an ester solvent of formula (I) wherein R₂ comprises an acyclic hydrocarbon chain having nine carbon atoms or less.

In some embodiments, the slurry does not include Chemical Formula Z1, Chemical Formula Z2, or neither Chemical Formula Z1 nor Chemical Formula Z2, wherein Chemical Formula Z1 is CH₃C(═O)O—R₁, and R₁ is a C₇-C₉ linear or branched alkyl, a C₇-C₉ linear or branched alkenyl; and Chemical Formula Z2 is CH₃CH₂C(═O)O—R₂, and R₂ is a C₅-C₉ linear or branched alkyl, a C₅-C₉ linear or branched alkenyl.

In some embodiments, the ester solvent of formula (I) comprises either of the following ester solvents, or a combination thereof:

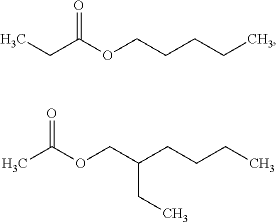

The slurry may include five or less total solvents, four or less total solvents, three or less total solvents, two or less total solvents, or a single solvent.

The ester solvent may have Hansen Solubility Parameters following the formula:

$${δ}^{2} = {( δ D )}^{2} + {( δ P )}^{2} + {( δ H )}^{2}$$

wherein δ is a Hansen solubility parameter, and δ is from about 16.4 MPa^{1/2} to about 18.2 MPa^{1/2}; δD is a dispersion energy parameter, and δD is from about 15 MPa^{1/2} to about 18.2 MPa^{1/2}; δP is a polar dipolar energy parameter, and δP is from about 0 MPa^{1/2} to about 6 MPa^{1/2}; and δH is a hydrogen bonding energy parameter, and δH is from about 0 MPa^{1/2} to about 6 MPa^{1/2}.

In some embodiments, δP is from about 2 MPa^{1/2} to about 6 MPa^{1/2}. In another embodiment, δP is from about 4 MPa^{1/2} to about 6 MPa^{1/2}. In other examples, δP is greater than 4 MPa^{1/2} to about 6 MPa^{1/2}. For example, δP may be about 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, or about 6.0 MPa^{1/2}.

These ester solvents may be preferred in some cases, as they enhance the stability of the slurry (e.g., particles in the slurry remain in suspension for long periods of time after mixing) without degrading or reacting with the solid-state electrolyte material.

In some non-limiting exemplary embodiments, the ester solvent may include 2-ethyl-hexyl acetate (also referred to herein as 2EHA, wherein R₁=methyl and R₂=a branched hydrocarbon chain containing eight carbon atoms), amyl propionate (also known as pentyl propanoate, wherein R₁=ethyl and R₂=a linear hydrocarbon chain containing five carbon atoms), or a combination thereof. In other non-limiting exemplary embodiments, the ester solvent may include octyl acetate (wherein R₁=methyl and R₂=a linear hydrocarbon chain containing eight carbon atoms).

In some embodiments, the ester solvent may comprise ethyl-hexyl acetate and amyl propionate.

The ester solvent may have a boiling point from about 140° F. to about 450° F. For example, the ester solvent may have a boiling point from about 140° F. to about 200° F., about 140° F. to about 250° F., about 140° F. to about 300° F., about 140° F. to about 350° F., about 140° F. to about 400° F., about 140° F. to about 450° F., about 200° F. to about 450° F., about 250° F. to about 450° F., about 300° F. to about 450° F., about 350° F. to about 450° F., about 400° F. to about 450° F., about 200° F. to about 400° F., or about 250° F. to about 350° F. In some embodiments, the ester solvent may have a boiling point from about 333 to about 391° F. In some embodiments, the ester solvent may have a boiling point from about 389 to about 391° F. In some embodiments, the ester solvent may have a boiling point from about 333 to about 337° F.

The ester solvent may have a density from about 0.85 to about 0.9 grams per milliliter (g/mL) at 25° C. In some embodiments, the ester solvent may have a density from about 0.86 to about 0.88 grams per milliliter (g/mL) at 25° C.

The ester solvent and the hydrocarbon-based solvent may be present in a weight ratio from about 99:1 (hydrocarbon:ester) to about 1:99, such as from about 99:1 to about 90:10, about 99:1 to about 80:20, about 99:1 to about 70:30, about 99:1 to about 60:40, about 99:1 to about 50:50, about 90:10 to about 50:50, about 80:20 to about 50:50, about 70:30 to about 50:50, or about 60:40 to about 50:50. As another example, the ester solvent and the hydrocarbon-based solvent may be present in a weight ratio from about 99:1 to about 50:1, about 99:1 to about 20:1, about 99:1 to about 10:1, about 99:1 to about 5:1, about 99:1 to about 1:1, about 99:1 to about 1:5, about 99:1 to about 1:10, about 99:1 to about 1:20, about 99:1 to about 1:50, about 99:1 to about 1:99, about 50:1 to about 1:99, about 20:1 to about 1:99, about 10:1 to about 1:99, about 5:1 to about 1:99, about 1:1 to about 1:99, about 1:5 to about 1:99, about 1:10 to about 1:99, about 1:20 to about 1:99, about 1:50 to about 1:99, about 50:1 to about 1:50, about 20:1 to about 1:20, about 10:1 to about 1:0, about 5:1 to about 1:5, or about 2:1 to about 1:2.

The slurry may be an electrode slurry. The electrode slurry may comprise an electrode active material (such as an anode active material or a cathode active material), a conductive additive, a solid-state electrolyte material, a binder, and a solvent as described above. Alternatively, the slurry may be a separator slurry. The separator slurry may comprise a solid-state electrolyte material, a binder, a conductive additive, and a solvent as described above.

The slurry may further comprise a binder. In some embodiments, the binder may include fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVDF), polyhexafluoropropylene (PHFP), and polytetrafluoroethylene (PTFE), and binary copolymers such as copolymers of VdF and HFP such as poly (vinylene difluoride-hexafluoropropylene) copolymer (PVDF-HFP), and the like. In another embodiment, the binder may be one or more of a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, Poly (methacrylate) nitrile-butadiene rubber (PMMA-NBR) and the like. In a further embodiment, the binder may be one or more of an acrylic resin such as but not limited to polymethyl (meth) acrylate, polyethyl (meth) acrylate, polyisopropyl (meth) acrylate polyisobutyl (meth) acrylate, polybutyl (meth)acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), and mixtures thereof.

Preferably, the binder comprises a thermoplastic elastomer such as those comprising styrene and butadiene. For example, the binder may comprise styrene-butadiene-styrene copolymer (SBS), styrene-isoprene block copolymer (SIS), styrene-ethylene-butylene-styrene (SEBS), or combinations thereof.

In some embodiments, the binder may comprise a high molecular weight binder and a low molecular weight binder. The high molecular weight binder may be the same species of binder as the low molecular weight binder, or it may be different. The high molecular weight binder has a longer polymer chain as compared to the low molecular weight binder. High molecular weight binders, as described herein, have a molecular weight of about 300,000 g/mol or higher. Low molecular weight binders, as described herein, have a molecular weight of about 100,000 or lower.

Without wishing to be bound by theory, it is the understanding of the inventors that the high molecular weight binder, with more long-range mechanical interactions, leads to a higher elongation stress of the resultant electrochemical cell layer. Further, it is the understanding of the inventors that the low molecular weight binder more readily adsorbs onto the surface of materials in the slurry due to lower steric hinderance, and thus leads to a greater elongation strain in the resultant electrochemical cell layer. The low molecular weight binder also has greater elongation strain due to smaller-range interactions. When the binders are mixed, the favorable long-range mechanical interactions and adsorption properties improve the mechanical properties of the resultant electrochemical cell layer.

In embodiments wherein the slurry comprises a high molecular weight binder and a low molecular weight binder, the high molecular weight binder and the low molecular weight binder may be present in a weight ratio from about 10:90 to about 90:10, such as from about 10:90 to about 20:80, about 10:90 to about 30:70, about 10:90 to about 40:60, about 10:90 to about 50:50, about 10:90 to about 60:40, about 10:90 to about 70:30, about 10:90 to about 80:20, about 10:90 to about 90:10, about 20:80 to about 90:10, about 30:70 to about 90:10, about 40:60 to about 90:10, about 50:50 to about 90:10, about 60:40 to about 90:10, about 70:30 to about 90:10, about 80:20 to about 90:10, about 20:80 to about 80:20, about 25:75 to about 75:25, or about 30:70 to about 70:30.

The binder may be present in the slurry in an amount from about 0.1% to about 35% by weight, such as from about 1% to about 30% by weight of the slurry. For example, the binder may be present in the slurry in an amount from about 0.1% to about 1%, about 0.1% to about 5%, about 0.1% to about 10%, about 0.1% to about 15%, about 0.1% to about 20%, about 0.1% to about 25%, about 0.1% to about 30%, about 0.1% to about 35%, about 1% to about 35%, about 5% to about 35%, about 10% to about 35%, about 15% to about 35%, about 20% to about 30%, about 25% to about 35%, about 30% to about 35%, about 5% to about 15%, about 5% to about 20%, about 10% to about 15%, about 10% to about 20%, or about 15% to about 20% by weight of the slurry. In some embodiments, the binder may be present in the slurry in an amount of about 0.1%, 0.5%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or about 35% by weight of the slurry.

The slurry may further comprise a conductive additive. The conductive additive helps to evenly distribute the charge density throughout the anode. The conductive additives may include metal powders, fibers, filaments, or any other material known to conduct electrons. The conductive additive may comprise a carbon-based conductive additive, such as carbon fiber, graphite, graphene, carbon black, conductive carbon, amorphous carbon, vapor grown carbon fiber (VGCF), carbon nanotubes, carbon nanostructures, carbon nanowires, activated carbon, and combinations thereof.

In some embodiments, the conductive additive may be present in the slurry in an amount from about 0% to about 15% by weight. In some aspects, the conductive additive may be present in the slurry in an amount from about 0% to about 10%, or about 0% to about 5% by weight. In some additional aspects, the conductive additive may be present in the slurry in an amount of about 0%, 1%, 2%, 3%, 4%, 5%, 6%, 7%, 8%, 9%, 10%, 11%, 12%, 13%, 14%, or about 15% by weight. In an example embodiment, the conductive additive is present in the slurry in an amount from about 0% to about 5% by weight.

In some embodiments, the average particle size of the conductive additive may be from about 5 nm to about 1000 nm. In some aspects, the average particle size of the conductive additive may be about from 5 nm to about 100 nm, about 5 nm to about 200 nm, about 5 nm to about 300 nm, about 5 nm to about 400 nm, about 5 nm to about 500 nm, about 5 nm to about 600 nm, about 5 nm to about 700 nm, about 5 nm to about 800 nm, about 5 nm to about 900 nm, about 100 nm to about 1000 nm, about 200 nm to about 1000 nm, about 300 nm to about 1000 nm, about 400 nm to about 1000 nm, about 500 nm to about 1000 nm, about 600 nm to about 1000 nm, about 700 nm to about 1000 nm, about 800 nm to about 1000 nm, about 900 nm to about 1000 nm, about 100 nm to about 500 nm, or about 200 nm to about 400 nm. In some embodiments, the conductive additive may have a particle size of about 5 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, or about 1000 nm. In some examples, the conductive additive may have an average particle size of about 30 nm. The average particle size (e.g., D50) may be determined through any method known to those having ordinary skill in the art, for example, by a particle size analyzer or a transmission electron microscope photograph or a scanning electron microscope photograph. Alternatively, the size may be measured using a dynamic light scattering method, and data analysis may be performed to count the number of particles with respect to each particle size range, and then calculated to obtain an average particle diameter value. Unless otherwise specified, the average particle diameter may be measured by a particle size analyzer, and refers to a diameter (D50) of particles having a cumulative volume of 50 vol % in a particle size distribution.

The slurry further comprises a solid electrolyte material. The solid electrolyte material may comprise an oxide, oxysulfide, sulfide, halide, nitride, or any other solid electrolyte known in the art. In some preferred embodiments, the solid electrolyte materials may comprise a sulfide solid electrolyte material, i.e., a solid electrolyte having at least one sulfur component. In some embodiments, the one or more solid electrolytes may comprise one or more material combinations such as Li₂S—P₂S₅, Li₂S—P₂S₅—LiI, Li₂S—P₂S₅—GeS₂, Li2_{S}—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, A1, Ga or In). Halide solid electrolytes may have the structure Li—M—X, M is a metal element, and X is a halogen. These can be expressed by the generic formula Li_{α}M⁴⁺_{β}N³⁺_{(1-β)}X_{Ω}Y_{(6-Ω)}, where: 0≤β≤1; 0≤Ω≤6; α=6−[(β*4)+(1−β)*3]; X and Y are a halogen such as F, Cl, Br, I; M is an element with an oxidation state of 4+ such as Ti, Zr, Hf, and Rf; and N is an element an oxidation state of 3+such as Ga, In, and Tl, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

In another embodiment, the solid electrolyte material may be one or more of a Li₃PS₄, Li₄P₂S₆, Li₇P₃S₁₁, Li₁₀GeP₂S₁₂, Li₁₀SnP₂S₁₂. In a further embodiment, the solid electrolyte material may be one or more of a Li₆PS₅Cl, Li₆PS₅Br, Li₆PS₅I or expressed by the formula Li_{7-y}PS_{6-y}X_{y} where “X” represents at least one halogen and/or at least one pseudo-halogen, and where 0<y≤2.0 and where the halogen may be one or more of F, Cl, Br, I, and the pseudo-halogen may be one or more of N, NH, NH₂, NO, NO₂, BF₄, BH₄, AlH₄, CN, and SCN. In some embodiments, the solid electrolyte material may include Li_{5.3}PS_{4.3}ClBr_{0.7}. In yet another embodiment, the solid electrolyte material be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, and SCN.

The solid-state electrolyte material may be present in the slurry in an amount from greater than 0% to about 70% by weight; for example, the solid-state electrolyte may be present in the slurry in an amount from greater than 0% to about 10% by weight, greater than 0% to about 20% by weight, greater than 0% to about 30% by weight, greater than 0% to about 40% by weight, greater than 0% to about 50% by weight, about 10% to about 60% by weight, about 20% to about 60% by weight, about 30% to about 60% by weight, about 40% to about 60% by weight, or about 50% to about 60% by weight. In some aspects, the solid-state electrolyte material may be present in the slurry in an amount of about 5%, 10%, 15%, 20%, 25%, 30%, 35%, 40%, 45%, 50%, 55%, or 60% by weight of the slurry. In an example embodiment, the solid-state electrolyte material is present in the slurry in an amount from about 35% to about 45% by weight.

The solid-state electrolyte material may have an average particle size from about 0.5 microns to about 50 microns, such as from about 0.5 microns to about 1 micron, about 0.5 microns to about 10 microns, about 0.5 microns to about 20 microns, about 0.5 microns to about 30 microns, about 0.5 microns to about 40 microns, about 0.5 microns to about 0.5 microns, about 1 micron to about 50 microns, about 10 microns to about 50 microns, about 20 microns to about 50 microns, about 30 microns to about 50 microns, or about 40 microns to about 50 microns.

The slurry may further comprise an electrode active material, such as an anode active material or a cathode active material, either alone or in combination with the solid electrolyte material.

The electrode active material may be present in the slurry in an amount from about 30% to about 98% by weight. In some aspects, the electrode active material may be present in the slurry in an amount of about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 98%, about 40% to about 98%, about 45% to about 98%, about 50% to about 98%, about 55% to about 98%, about 60% to about 98%, about 65% to about 98%, about 70% to about 98%, about 75% to about 98%, about 80% to about 98%, about 85% to about 98%, about 90% to about 98%, about 40% to about 90%, about 40% to about 80%, about 40% to about 70%, about 40% to about 60%, about 40% to about 55%, about 40% to about 50%, or about 40% to about 45% by weight.

In some embodiments, the slurry may comprise an anode active material. The anode active material preferably is an inorganic material. The anode active material may comprise one or more inorganic materials such as silicon (Si), silicon alloys, tin (Sn), tin alloys, germanium (Ge), germanium alloys, graphite, Li₄Ti₅O₁₂ (LTO) or other known anode active materials and combinations thereof.

In some embodiments, the slurry may comprise a cathode active material. The cathode active material may include nickel-manganese-cobalt (“NMC”) which can be expressed as Li(NiₐCo_{b}Mn_{c})O₂ (0<a<1, 0<b<1, 0<c<1, a+b+c=1) or, for example, NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂) or a combination thereof. In another embodiment, the cathode active material may comprise one or more of a coated or uncoated metal oxide, such as but not limited to V₂O₅, V₆O₁₃, MoO₃, LiCoO₂, LiNiO₂, LiMnO₂, LiMn₂O₄, LiNi_{1-Y}CO_{Y}O₂, LiCO_{1-Y}MA_{Y}O₂, LiNi_{1-Y}Mn_{Y}O₂ (0≤Y<1), Li(NiₐCo_{b}Mn_{c})O₄ (0<a<2, 0<b<2, 0<c<2, a+b+c=2), LiMn_{2-z}Ni_{z}O₄, LiMn_{2-z}Co₂O₄ (0<Z<2), LiCoPO₄, LiFePO₄, CuO, Li(NiₐCo_{b}Al_{c})O₂ (0<a<1, 0<b<1, 0<c<1, a+b+c=1) or a combination thereof. In yet another embodiment, the cathode active material may comprise one or more of a coated or uncoated metal sulfide such as but not limited to titanium sulfide (TiS₂), molybdenum sulfide (MoS₂), iron sulfide (FeS, FeS₂), copper sulfide (CuS), and nickel sulfide (Ni₃S₂) or combinations thereof. In still further embodiments, the cathode active material may comprise elemental sulfur(S). In additional embodiments, the cathode active material may comprise one or more of a fluoride cathode active material such as but not limited to lithium fluoride (LiF), sodium fluoride (NaF), calcium fluoride (CaF₂), magnesium fluoride (MgF₂), nickel (II) fluoride (NiF₂), iron (III) fluoride (FeF₃), vanadium (III) fluoride (VF₃), cobalt (III) fluoride (CoF₃), chromium (III) fluoride (CrF₃), manganese (III) fluoride (MnF₃), aluminum fluoride (AlF₃), and zirconium (IV) fluoride (ZrF₄), or combinations thereof.

The slurry of the present disclosure may have a solids content from about 10% to less than 100%. For example, the slurry may have a solids content from about 10% to about 20%, about 10% to about 30%, about 10% to about 40%, about 10% to about 50%, about 10% to about 60%, about 10% to about 70%, about 10% to about 80%, about 10% to about 90%, about 10% to less than 100%, about 20% to less than 100%, about 30% to less than 100%, about 40% to less than 100%, about 50% to less than 100%, about 60% to less than 100%, about 70% to less than 100%, about 80% to less than 100%, about 90% to less than 100%, about 50% to about 90%, about 60% to about 90%, or about 70% to about 90%.

The electrode slurry may have a viscosity from about 20 cP to about 3000 cP measured at a shear rate of about 100 s⁻¹. For example, the electrode slurry may have a viscosity form about 20 cP to about 100 cP, about 20 cP to about 500 cP, about 20 cP to about 1000 cP, about 20 cP to about 1500 cP, about 20 cP to about 2000 cP, about 20 cP to about 2500 cP, about 20 cP to about 3000 cP, about 100 cP to about 3000 cP, about 500 cP to about 3000 cP, about 1000 cP to about 3000 cP, about 1500 cP to about 3000 cP, about 2000 cP to about 3000 cP, or about 2500 cP to about 3000 cP. In some embodiments, the electrode slurry may have a viscosity of about 20 cP, 50 cP, 100 cP, 150 cP, 200 cP, 250 cP, 300 cP, 350 cP, 400 cP, 450 cP, 500 cP, 550 cP, 600 cP, 650 cP, 700 cP, 750 cP, 800 cP, 850 cP, 900 cP, 950 cP, 1000 cP, 1100 cP, 1200 cP, 1300 cP, 1400 cP, 1500 cP, 1600 cP, 1700 cP, 1800 cP, 1900 cP, 2000 cP, 2100 cP, 2200 cP, 2300 cP, 2400 cP, 2500 cP, 2600 cP, 2700 cP, 2800 cP, 2900 cP, or about 3000 cP measured at a shear rate of about 100 s⁻¹.

The slurry of the present disclosure may be used to make a separator layer or an electrode layer, where the electrode layer may be an anode layer or a cathode layer. The separator layer slurry is formed by combining one or more of an ester solvent, a solid electrolyte material, a hydrocarbon solvent, and binder. The electrode layer slurry is formed by combining one or more of an ester solvent, a solid electrolyte material, a hydrocarbon solvent, a conductive additive, a binder, and an electrode active material, wherein the electrode active material may be either an anode active material or a cathode active material. The combination may then be mixed to form a homogeneous slurry. Methods of combining and mixing are generally known to those having ordinary skill in the art. Methods of combining and mixing are generally known to those having ordinary skill in the art.

The slurry of the present disclosure may be an electrode slurry. The electrode slurry may comprise an electrode active material (such as an anode active material or a cathode active material) and a solvent, and, optionally, a conductive additive, a solid-state electrolyte material, a binder, an alkali metal carboxylate material, or any combination thereof. Alternatively, the slurry may be a separator slurry. The separator slurry may comprise a solid-state electrolyte material and a solvent, and, optionally, a binder, or any combination thereof.

In one embodiment, the slurry is a cathode slurry for an all-solid-state battery, comprising a cathode active material, a sulfide-based solid electrolyte, a binder, a conductive additive, and 2EHA, alone or in combination with a hydrocarbon solvent (e.g., xylene). In another embodiment, the invention comprises an anode composition for an all-solid-state battery comprises an anode active material, a sulfide-based solid electrolyte, a binder, a conductive additive, and 2EHA, alone or in combination with a hydrocarbon solvent (e.g., xylene).

In one embodiment, in the electrode slurry, the sulfide-based solid electrolyte, the binder, and the conductive additive may comprise from about 50 to about 100 parts by weight, and the solvent (or solvent mixture) may comprise about 5 parts by weight to about 100 parts by weight, for example, 5 parts by weight to 70 parts by weight, 10 parts by weight to 65 parts by weight, or 15 parts by weight to 65 parts by weight. US Publication No. 2024/0079639 A1 (U.S. application Ser. No. 18/162,930, filed Feb. 1, 2023), WO Publication No. 2023/238995 A1 (WO Application No. PCT/KR2022/016921, filed Nov. 1, 2022), and US Publication No. 2022/0069310 A1 (U.S. application Ser. No. 17/460,680, filed Aug. 30, 2021), are all hereby incorporated by reference in their entirety.

The alkali metal carboxylate may be represented by formula (II):

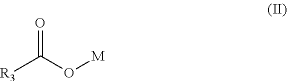

wherein R₃ comprises H or a hydrocarbon chain having one carbon atom (i.e., methyl or —CH₃) or two carbon atoms (i.e., ethyl or —CH₂CH₃), and wherein M comprises an alkali metal. In some embodiments, M may include lithium, sodium, or potassium. For example, when R₁ comprises a hydrocarbon chain having one carbon (i.e., methyl or —CH₃), the alkali metal carboxylate material may be Lithium acetate, sodium acetate, or potassium acetate. When R₁ comprises two carbons (i.e., ethyl or —CH₂CH₃), the alkali metal carboxylate material may be Lithium propionate, sodium propionate, or potassium propionate.

The alkali metal carboxylate may be present in the slurry in an amount from about 0% to about 15% by weight, from about 0% to about 10% by weight, from about 0% to about 5% by weight, or from about 0% to about 1% by weight. In some aspects, the alkali metal carboxylate material may be present in the slurry in an amount from about 0% to about 1%, or about 0% to about 0.5% by weight. In some aspects, the alkali metal carboxylate material may be present in the slurry in an amount from about 0% to about 0.1%, or about 0% to about 0.05% by weight. In some aspects, the alkali metal carboxylate material may be present in the slurry in an amount from about 0% to about 0.001%, or about 0% to about 0.005% by weight In some additional aspects, the conductive additive may be present in the slurry in an amount of about 0%, 0.001%, 0.002%, 0.003%, 0.004%, 0.005%, 0.006%, 0.007%, 0.008%, 0.009%, 0.01%, 0.02%, 0.03%, 0.04%, 0.05%, or about 0.1% by weight. In some aspects, the alkali metal carboxylate material may be present in the slurry in an amount from about 1 ppm to about 10 ppm, from about 1 ppm to about 9 ppm, from about 1 ppm to about 8 ppm, from about 1 ppm to about 7 ppm, from about 1 ppm to about 6 ppm, from about 1 ppm to about 5 ppm, from about 1 ppm to about 4 ppm, from about 1 ppm to about 3 ppm, or from about 1 ppm to about 2 ppm.

The average particle size of the alkali metal carboxylate material may be from about 5 nm to about 1000 nm. In some aspects, the average particle size of the alkali metal carboxylate material may be about from 5 nm to about 100 nm, about 5 nm to about 200 nm, about 5 nm to about 300 nm, about 5 nm to about 400 nm, about 5 nm to about 500 nm, about 5 nm to about 600 nm, about 5 nm to about 700 nm, about 5 nm to about 800 nm, about 5 nm to about 900 nm, about 100 nm to about 1000 nm, about 200 nm to about 1000 nm, about 300 nm to about 1000 nm, about 400 nm to about 1000 nm, about 500 nm to about 1000 nm, about 600 nm to about 1000 nm, about 700 nm to about 1000 nm, about 800 nm to about 1000 nm, about 900 nm to about 1000 nm, about 100 nm to about 500 nm, or about 200 nm to about 400 nm. In some embodiments, the alkali metal carboxylate material may have a particle size of about 5 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, or about 1000 nm. In some examples, the alkali metal carboxylate material may have an average particle size of about 30 nm. As previously, the average particle size (e.g., D₅₀) may be determined through any method known to those having ordinary skill in the art.

The amount and/or percentage distribution of the alkali metal carboxylate material in an electrode layer may not be uniform throughout the electrode layer. For example, there may be an alkali metal carboxylate concentration gradient present in the electrode layer, such that optionally a minimum concentration of the alkali metal carboxylate material is found within the section of the electrode layer that is in closer proximity to the current collector and a maximum concentration of the alkali metal carboxylate material may be found in section of the electrode layer that is in close proximity to the separator layer.

Further provided herein is an electrochemical cell layer comprising a solid-state electrolyte material, a high molecular weight binder, and a low molecular weight binder. The electrochemical cell layers are made by casting any one of the slurries described above.

The electrochemical cell layer may include an electrode layer or a separator layer. The electrode layer may include an electrode active material (i.e., an anode active material or a cathode active material), a solid-state electrolyte material, a high molecular weight binder, a low molecular weight binder, optionally an alkali metal carboxylate material, and optionally a conductive additive. The separator layer may include a solid-state electrolyte material, a high molecular weight binder, a low molecular weight binder, optionally an alkali metal carboxylate material, and optionally a conductive additive.

A separator layer made using the methods of the present disclosure may have an ionic conductivity of greater than about 0.15 mS. For example, the separator layer may have an ionic conductivity of greater than about 0.15 mS, greater than about 0.30 mS, greater than about 0.60 mS, or greater than about 1 mS.

The electrochemical cell layer may have a toughness of greater than about 100 kPa. For example, the electrochemical cell layer may have a toughness of greater than about 250 kPa, greater than about 500 kPa, greater than about 750 kPa, greater than about 1,000 kPa, greater than about 1,250 kPa, greater than about 1,500 kPa, greater than about 1,750 kPa, greater than about 2,000 kPa, or more. Methods for measuring toughness are generally known to those having ordinary skill in the art, such as dynamic mechanical analysis.

The electrochemical cell layer may have an elongation at break (i.e., a fracture strain, also referred to herein as elongation strain) from about 10% to about 30%. For example, the elongation at break may be from about 10% to about 15%, about 10% to about 20%, about 10% to about 25%, about 10% to about 30%, about 15% to about 30%, about 20% to about 30%, or about 25% to about 30%.

The electrochemical cell layer may have an elongation stress from about 3.5 to about 5. For example, the electrochemical cell layer may have an elongation stress from about 3.5 to about 4, about 3.5 to about 4.5, about 3.5 to about 5, about 4 to about 5, about 4.5 to about 5, or about 4 to about 4.5. As another example, the electrochemical cell layer may have an elongation stress of about 3.5, 3.6, 3.7, 3.8, 3.9, 4.0, 4.1, 4.2, 4.3, 4.4, 4.5, 4.6, 4.7, 4.8, 4.9, or about 5.0.

The electrochemical cell layer may include any solid electrolyte material previously described herein. The electrochemical cell layer may include a solid electrolyte material in an amount from about 30% to about 99% by weight. In some aspects, the solid electrolyte material may be present in the electrochemical cell layer in an amount of about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 99%, about 40% to about 99%, about 45% to about 99%, about 50% to about 99%, about 55% to about 99%, about 60% to about 99%, about 65% to about 99%, about 70% to about 99%, about 75% to about 99%, about 80% to about 99%, about 85% to about 99%, about 90% to about 99%, about 40% to about 90%, about 40% to about 80%, about 40% to about 70%, about 40% to about 60%, about 40% to about 55%, about 40% to about 50%, or about 40% to about 45% by weight.

When the electrochemical cell layer is a separator layer, the electrochemical cell layer may include a solid electrolyte material in an amount from about 60% to about 99% by weight. In some aspects, the solid electrolyte material may be present in the electrochemical cell layer in an amount of about 60% to about 65%, about 60% to about 70%, about 60% to about 75%, about 60% to about 80%, about 60% to about 85%, about 60% to about 90%, about 60% to about 95%, about 60% to about 99%, about 65% to about 99%, about 70% to about 99%, about 75% to about 99%, about 80% to about 99%, about 85% to about 99%, about 90% to about 99%, or about 70% to about 90% by weight.

The binder may be present in the electrochemical cell layer in an amount from about 1% to about 30% by weight. For example, the binder may be present in the electrochemical cell layer in an amount from about 1% to about 5%, about 1% to about 10%, about 1% to about 15%, about 1% to about 20%, about 1% to about 25%, about 1% to about 30%, about 5% to about 30%, about 10% to about 30%, about 15% to about 30%, about 20% to about 30%, about 25% to about 30%, about 5% to about 15%, about 5% to about 20%, about 10% to about 15%, about 10% to about 20%, or about 15% to about 20% by weight.

The conductive additive may be present in the electrochemical cell layer in an amount from about 0% to about 15% by weight. In some aspects, the conductive additive may be present in the electrochemical cell layer in an amount from about 0% to about 10%, or about 0% to about 5% by weight. In some additional aspects, the conductive additive may be present in the electrochemical cell layer in an amount of about 0%, 1%, 2%, 3%, 4%, 5%, 6%, 7%, 8%, 9%, 10%, 11%, 12%, 13%, 14%, or about 15% by weight. In an example embodiment, the conductive additive is present in the electrochemical cell layer in an amount from about 0% to about 5% by weight.

The electrode active material may be present in the electrochemical cell layer in an amount from about 30% to about 98% by weight. In some aspects, the electrode active material may be present in the electrochemical cell layer in an amount of about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 98%, about 40% to about 98%, about 45% to about 98%, about 50% to about 98%, about 55% to about 98%, about 60% to about 98%, about 65% to about 98%, about 70% to about 98%, about 75% to about 98%, about 80% to about 98%, about 85% to about 98%, about 90% to about 98%, about 40% to about 90%, about 40% to about 80%, about 40% to about 70%, about 40% to about 60%, about 40% to about 55%, about 40% to about 50%, or about 40% to about 45% by weight.

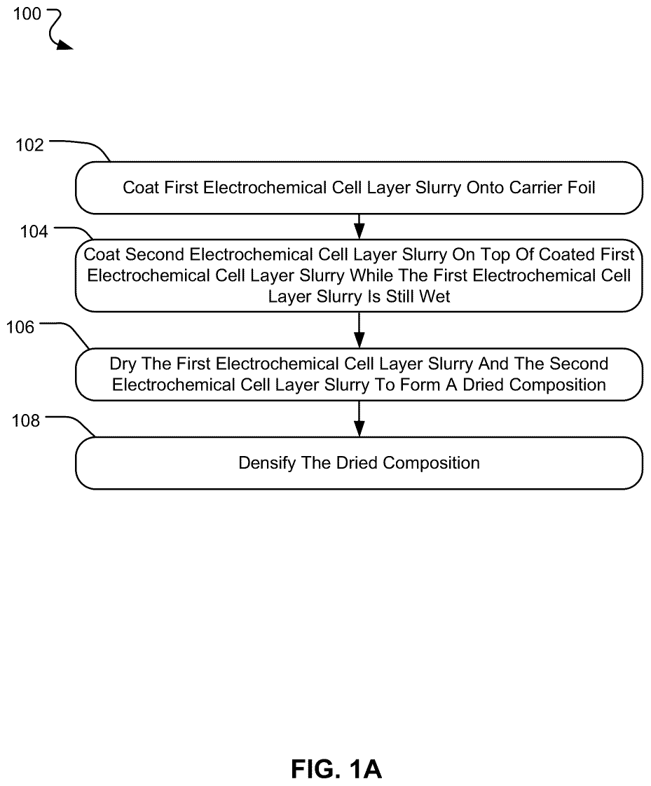

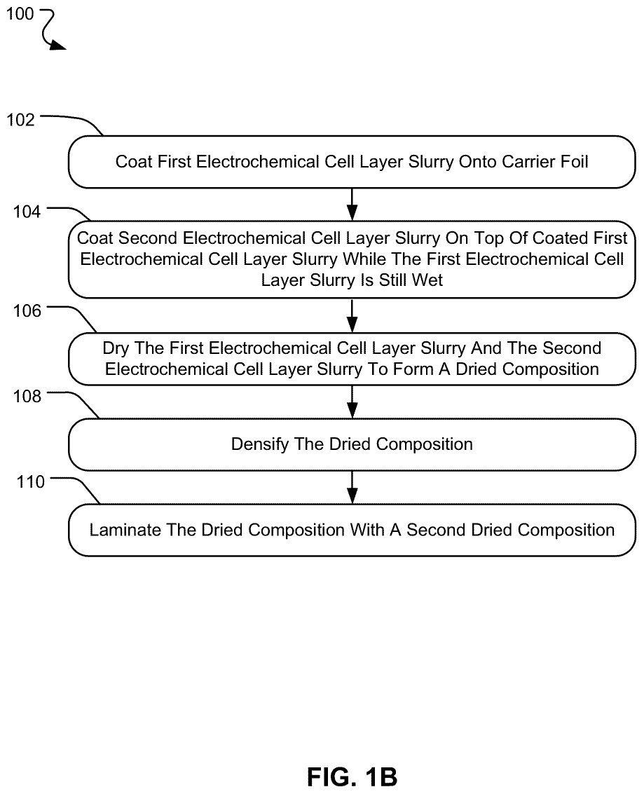

A process for preparing an electrochemical cell layer using a slurry of the present disclosure is shown in FIG. 1A. The process 100 begins at step 102 by coating the slurry onto a surface. The slurry may be any slurry described above, including an electrode slurry (e.g., an anode slurry or a cathode slurry), a separator slurry, or another slurry to make another electrochemical cell layer. The surface may comprise a carrier foil, a current collector, a dried electrochemical cell layer, or another surface. The coating may be accomplished by pouring the slurry onto a surface via gravity or by pumping the slurry onto the surface. The process may take place in ambient conditions, or may take place in an inert atmosphere such as nitrogen or argon. In some embodiments, the process may be conducted in an atmosphere comprising air and moisture. In other embodiments, the process may be conducted in an atmosphere comprising air and substantially no moisture (i.e., less than 1% humidity).

The slurry may be coated onto the surface at ambient temperature and pressure. In some aspects, the slurry may be coated onto the surface at a temperature up to the boiling point of the solvent system used in the slurry, or the slurry may be coated at cooler temperatures to limit vaporization of the solvent.

The process 100 continues at step 106 by drying the coated slurry to form a dried composition including at least one electrochemical cell layer. The drying at step 106 may occur at a temperature from about 15° C. to about 300° C. For example, the drying step 106 may occur at a temperature from about 15° C. to about 30° C., about 15° C. to about 50° C., about 15° C. to about 100° C., about 15° C. to about 150° C., about 15° C. to about 200° C., about 15° C. to about 250° C., about 15° C. to about 300° C., about 30° C. to about 300° C., about 50° C. to about 300° C., about 100° C. to about 300° C., about 150° C. to about 300° C., about 200° C. to about 300° C., or about 250° C. to about 300° C. In some embodiments, the drying step 106 may occur at a temperature of about 15° C., 20° C., 25° C., 30° C., 35° C., 40° C., 45° C., 50° C., 60° C., 70° C., 80° C., 90° C., 100° C., 125° C., 150° C., 175° C., 200° C., 225° C., 250° C., 275° C., or about 300° C. In some embodiments, the drying step 106 occurs at a temperature of 100° C. or less, 90° C. or less, 80° C. or less, 70° C. or less, or 60° C. or less.

After the drying step is completed, the amount of solvent left in the dried composition may range from 0.1% to 0% by weight of the composition.

After the drying step is completed, the amount of solvent left in the dried composition may optionally form an even coating (e.g., a uniformly wet manner) or an uneven coating on the dried composition.

If there is solvent remaining in the dried composition, the electrochemical performance of an electrochemical cell containing this dried composite may be negatively affected.

The process 100 continues at step 108 by densifying the dried composition. The composition may be densified through densification processes known to those having ordinary skill in the art, such as calendaring, linear densification, compaction, or compression. In preferred embodiments, the densifying may be accomplished via calendering.

The dried composition may have a density after densification from about 50% to about 99% of the theoretical density of the composition. The theoretical density is defined as the maximum density of the composition that could be achieved assuming there are no voids or contaminants. The density may be from about 50% to about 60%, about 50% to about 70%, about 50% to about 80%, about 50% to about 90%, about 50% to about 95%, about 50% to about 99%, about 60% to about 99%, about 70% to about 99%, about 80% to about 99%, about 90% to about 99%, or about 95% to about 99% of the theoretical density of the dried composition.

The dried composition may have a porosity from about 1% to about 70%. For example, the dried composition may have a porosity from about 1% to about 10%, about 1% to about 20%, about 1% to about 30%, about 1% to about 40%, about 1% to about 50%, about 1% to about 60%, about 1% to about 70%, about 10% to about 70%, about 20% to about 70%, about 30% to about 70%, about 40% to about 70%, about 50% to about 70%, or about 60% to about 70%. The porosity of the dried composition may be measured through techniques known in the art, such as through SEM imaging, TEM imaging, FIB-SEM imaging, confocal microscopy, gas adsorption, mercury porosimetry, helium pycnometry, or other methods known in the art.

In another embodiment, as shown in FIG. 1B, the process 100 may further comprise step 110 of laminating the dried composition with a second dried composition. The lamination may be accomplished by lamination methods generally well known in the art, such as by calendar rolling. The lamination may further increase the density of the dried composition. The second dried composition may or may not contain a binder concentration gradient.

The second dried composition may comprise a third electrochemical cell layer. The third electrochemical cell layer may be a separator layer, an electrode layer, or another layer electrochemical cell layer. The second dried composition may be produced using the processes described herein, or it may be produced using a different process. Generally, the second dried composition may be individually calendered separately from the first dried composition. The first dried composition and the second dried composition may be laminated together such that the second electrochemical cell layer is in contact with the third electrochemical cell layer; however, it will be appreciated by those having ordinary skill in the art that the first dried composition and the second dried composition may be laminated together such that the first electrochemical cell layer is in contact with the third electrochemical cell layer.

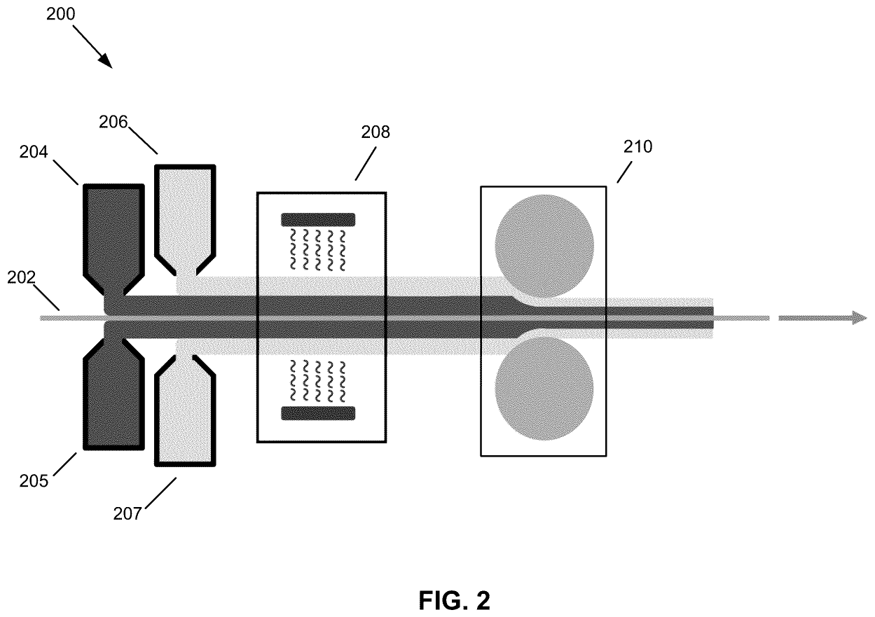

A depiction of an example process apparatus is shown in FIG. 2. Referring to FIG. 2, the apparatus 200 has two sides: Side A and Side B. The apparatus includes a surface 202, a first electrochemical cell layer slurry 204, a third electrochemical cell layer slurry 205, a second electrochemical cell layer slurry 206 a fourth electrochemical cell layer slurry 207, a drying module 208, and a densifying module 210. The two sides are oriented vertically, as shown in FIG. 2. Thus, the first electrochemical cell layer slurry 205 is deposited onto the surface 202 from below the surface 202. Likewise, the second electrochemical cell layer slurry 207 is deposited onto the surface 202 from below the surface 202. The inventors have surprisingly found that the slurries defined herein are capable of adhering to the surface 202 from below without falling or dripping from the surface 202. It will be appreciated by those having skill in the art that the process may be performed using only one of the sides; however, for efficiency and maximizing output, use of both sides is preferred.

The surface 202 may comprise a carrier foil or a current collector. The carrier foil or the current collector may comprise one or more of copper, aluminum, nickel, titanium, stainless steel, magnesium, iron, zinc, indium, germanium, silver, platinum, or gold. In some embodiments, the surface may include a metalized polymer film. In some embodiments, the current collector may have a thickness from about 5 μm to about 10 μm. In some embodiments, the current collector includes a carbon coating. In preferred embodiments, the current collector comprises copper, nickel, and/or steel. Alternatively, the surface 402 may comprise a dried electrochemical cell layer.

The apparatus 200 shown in FIG. 2 may be used in a process for producing electrochemical cells as described herein. The process generally includes simultaneously coating a top side and a bottom side of a two-sided surface with a first wet electrode slurry and a second wet electrode slurry, respectively; and, simultaneously coating a first separator slurry and a second separator slurry on each of the respective top and bottom coated wet electrode slurry resulting in two parallel regions of wet-on-wet areas of contact between electrode and separator to physically form two neighboring electrochemical cell portions of a solid state battery. The first and second wet electrode slurries may each be any of the electrode slurries described herein. The first and second separator slurries may each be any of the separator slurries described herein. The two-sided surface may be any of the surfaces provided herein.

### ENUMERATED EMBODIMENTS

Embodiment 1: A slurry comprising:
an ester solvent having Hansen Solubility Parameters following the formula:

$$δ {‐}^{2} = {( δ D )}^{2} + {( δ P )}^{2} + {( δ H )}^{2} ,$$

wherein:
   δ is from about 16.4 MPa^{1/2} to about 18.2 MPa^{1/2};
   δD is from about 15 MPa^{1/2} to about 18.2 MPa^{1/2};
   δP is from greater than 4 MPa^{1/2} to about 6 MPa^{1/2}; and
   δH is from about 0 MPa^{1/2} to about 6 MPa^{1/2}, and
wherein the ester solvent has the formula:

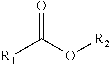

wherein R₁ is H, methyl, ethyl, or propyl, and R₂ is an acyclic linear or branched hydrocarbon chain having five carbon atoms or more;
a hydrocarbon solvent;
a low molecular weight binder having a molecular weight of 100,000 or less; and
a high molecular weight binder having a molecular weight of 300,000 or more.

Embodiment 2: The slurry of embodiment 1, wherein the hydrocarbon solvent comprises xylene, toluene, benzene, hexane, heptane, octane, or any combination thereof.

Embodiment 3: The slurry of embodiments 1 or 2, wherein the ester solvent comprises 2-ethyl-hexyl acetate.

Embodiment 4: The slurry of any one of embodiments 1-3, wherein the ester solvent comprises amyl propionate.

Embodiment 5: The slurry of any one of embodiments 1-4, wherein the low molecular weight binder and the high molecular weight binder are the same species of binder with differing polymer chain lengths.

Embodiment 6: The slurry of any one of embodiments 1-5, wherein the weight ratio of the high molecular weight binder to the low molecular weight binder is from about 10:90 to about 90:10.

Embodiment 7: The slurry of any one of embodiments 1-6, further comprising a solid electrolyte material.

Embodiment 8: The slurry of any one of embodiments 1-7, further comprising an electrode active material.

Embodiment 9: The slurry of any one of embodiments 1-8, further comprising a conductive additive.

Embodiment 10: An electrochemical cell layer comprising:
a solid-state electrolyte material;
a low molecular weight binder having a molecular weight of 100,000 or less;
a high molecular weight binder having a molecular weight of 300,000 or more; and
wherein the weight ratio of the high molecular weight binder to the low molecular weight binder is from about 10:90 to about 90:10.

Embodiment 11: The electrochemical cell of embodiment 10, wherein the low molecular weight binder and the high molecular weight binder are the same species of binder with differing polymer chain lengths.

Embodiment 12: The electrochemical cell of embodiment 10 or 11, further comprising an electrode active material.

Embodiment 13: The electrochemical cell of any one of embodiments 10-12, further comprising a conductive additive.

Embodiment 14: The electrochemical cell of any one of embodiments 10-13, further comprising an alkali metal carboxylate material having the formula:

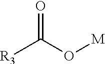

wherein R₃ comprises H, methyl, or ethyl, and
wherein M comprises an alkali metal.

Embodiment 15: The electrochemical cell of embodiment 14, wherein M comprises lithium, sodium, potassium, or a combination thereof.

Embodiment 16: An electrochemical cell comprising:
a cathode layer comprising a cathode active material;
a separator layer comprising a solid electrolyte material, a high molecular weight binder having a molecular weight of 300,000 or more, and a low molecular weight binder having a molecular weight of 100,000 or less, wherein the weight ratio of the high molecular weight binder to the low molecular weight binder is from about 10:90 to about 90:10; and
an anode layer comprising an anode active material.

Embodiment 17: The electrochemical cell of embodiment 16, wherein the low molecular weight binder and the high molecular weight binder are the same species of binder with differing polymer chain lengths.

Embodiment 18: The electrochemical cell of embodiment 16 or 17, wherein the cathode layer further comprises:
a high molecular weight binder, wherein the molecular weight is 300,000 or more, and
a low molecular weight binder wherein the molecular weight is 100,000 or less,
wherein the weight ratio of the high molecular weight binder to the low molecular weight binder is from about 10:90 to about 90:10.

Embodiment 19: The electrochemical cell of any one of embodiments 16-18, wherein the cathode layer further comprises an alkali metal carboxylate material having the formula:

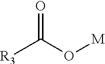

wherein R₃ comprises H, methyl, or ethyl, and
wherein M comprises an alkali metal.

Embodiment 20: A slurry comprising:
an ester solvent, the ester solvent having the formula:

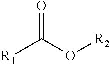

wherein R₁ is H, methyl, ethyl, or propyl, and R₂ is an acyclic linear or branched hydrocarbon chain having five carbon atoms or more;
a hydrocarbon solvent; and
a binder.

Embodiment 21: The slurry of embodiment 20, wherein R₁ is methyl, R₂ is an acyclic linear or branched hydrocarbon chain having eight carbon atoms.

Embodiment 22: The slurry of embodiment 20 or 21, wherein the ester solvent has a boiling point from about 333 to about 391° F.

Embodiment 23: The slurry of any one of embodiments 20-22, wherein the ester solvent has a boiling point from about 389 to about 391° F.

Embodiment 24: The slurry of any one of embodiments 20-23, wherein the ester solvent has a density from about 0.86 to about 0.88 grams per milliliter (g/mL) at 25° C.

Embodiment 25: The slurry of any one of embodiments 20-24, wherein the hydrocarbon solvent comprises xylene, toluene, benzene, hexane, heptane, octane, or any combination thereof.

Embodiment 26: The slurry of any one of embodiments 20-25, wherein hydrocarbon solvent comprises heptane.

Embodiment 27: The slurry of any one of embodiments 20-26, wherein the hydrocarbon solvent comprises xylene.

Embodiment 28: The slurry of any one of embodiments 20-27, wherein the solvents in the slurry consist of only the ester solvent and the hydrocarbon solvent.

Embodiment 29: The slurry of any one of embodiments 20-27, wherein the slurry comprises a third solvent.

Embodiment 30: The slurry of any one of embodiments 20-29, wherein the ester solvent comprises 2-ethyl-hexyl acetate.

Embodiment 31: The slurry of embodiment 30, wherein the ester solvent further comprises amyl propionate.

Embodiment 32: The slurry of any one of embodiments 20-29, wherein the ester solvent consists of 2-ethyl-hexyl acetate.

Embodiment 33: The slurry of any one of embodiments 20-32, wherein the slurry does not include an ester solvent wherein R₁ is ethyl.

Embodiment 34: The slurry of any one of embodiments 20-33, wherein the slurry does not include an ester solvent wherein R₁ is a hydrocarbon chain having three or more carbon atoms.

Embodiment 35: The slurry of any one of embodiments 20-34, wherein the slurry does not include an ester solvent wherein R₂ is an acyclic hydrocarbon chain having seven or less carbon atoms.

Embodiment 36: The slurry of any one of embodiments 20-35, wherein the slurry does not include an ester solvent wherein R₂ is an acyclic hydrocarbon chain having nine or more carbon atoms.

Embodiment 37: The slurry of any one of embodiments 20-35, further comprising an alkali metal carboxylate material having the formula:

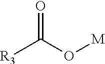

wherein R₃ comprises H, methyl, or ethyl, and
wherein M comprises an alkali metal.

Embodiment 38: The slurry of embodiment 37, wherein M comprises lithium, sodium, potassium, or a combination thereof.

Embodiment 39: A slurry comprising:
an ester solvent, the ester solvent having the formula

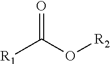

wherein R₁ is ethyl and R₂ is an acyclic linear or branched hydrocarbon chain containing five carbon atoms,
a hydrocarbon solvent; and
a binder.

Embodiment 40: The slurry of embodiment 39, wherein the ester solvent has a boiling point from about 333 to about 391° F.

Embodiment 41: The slurry of embodiment 39 or 40, wherein the ester solvent has a boiling point from about 333 to about 337° F.

Embodiment 42: The slurry of any one of embodiments 39-41, wherein the hydrocarbon solvent comprises xylene, toluene, benzene, hexane, heptane, octane, or combinations thereof.

Embodiment 43: The slurry of any one of embodiments 39-42, wherein hydrocarbon solvent comprises heptane.

Embodiment 44: The slurry of any one of embodiments 39-43, wherein hydrocarbon solvent comprises xylene.

Embodiment 45: The slurry of any one of embodiments 39-44, wherein the slurry comprises only two solvents.

Embodiment 46: The slurry of any one of embodiments 39-44, wherein the slurry comprises only three solvents.

Embodiment 47: The slurry of any one of embodiments 39-46, wherein the ester solvent comprises amyl propionate.

Embodiment 48: The slurry of embodiment 47, wherein the ester solvent further comprises 2-ethyl-hexyl acetate.

Embodiment 49: The slurry of any one of embodiments 39-47, wherein the ester solvent consists of amyl propionate.

Embodiment 50: The slurry of any one of embodiments 39-49, wherein the slurry does not include an ester solvent wherein R₁ is methyl.

Embodiment 51: The slurry of any one of embodiments 39-50, wherein the slurry does not include an ester solvent wherein R₁ is a hydrocarbon chain having three or more carbon atoms.

Embodiment 52: The slurry of any one of embodiments 39-51, wherein the slurry does not include an ester solvent wherein R₂ is an acyclic linear or branched hydrocarbon chain having four or less carbon atoms.

Embodiment 53: The slurry of any one of embodiments 39-51, wherein the slurry does not include an ester solvent wherein R₂ is an acyclic linear or branched hydrocarbon chain having six or more carbon atoms.

Embodiment 54: The slurry of any one of embodiments 39-52, wherein the slurry does not include an ester solvent wherein R₂ is an acyclic linear or branched hydrocarbon chain having nine or more carbon atoms.

Embodiment 55: The slurry of any one of embodiments 39-52, further comprising an alkali metal carboxylate material having the formula

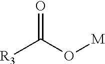

wherein R₃ comprises H, methyl, or ethyl, and
wherein M comprises an alkali metal.

Embodiment 56: The slurry of embodiment 55, wherein M comprises lithium, sodium, potassium, or a combination thereof.

Embodiment 57: The slurry of any one of embodiments 39-56, wherein the binder comprises a low molecular weight binder and a high molecular weight binder.

Embodiment 58: The slurry of embodiment 57, wherein the weight ratio of the high molecular weight binder to the low molecular weight is from about 10:90 to about 90:10.

Embodiment 59: The slurry of embodiment 57 or 58, wherein the low molecular weight binder and the high molecular weight binder are the same species of binder with differing polymer chain lengths.

Embodiment 60: The slurry of any one of embodiments 39-59, further comprising a solid electrolyte material.

Embodiment 61: The slurry of embodiment 60, wherein the solid electrolyte material is present in the slurry in an amount from about 60% by weight to about 99% by weight.

Embodiment 62: The slurry of any one of embodiments 39-61, further comprising a conductive additive.

Embodiment 63: The slurry of any one of embodiments 39-62, further comprising an electrode active material.

Embodiment 64: The slurry of any one of embodiments 39-63, wherein the binder is present in the slurry in an amount from about 1% by weight of the slurry to about 30% by weight of the slurry.

Embodiment 65: The slurry of any one of embodiments 39-64, wherein the ester solvent has Hansen Solubility Parameters following the formula:

δ²=(δD)²+(δP)²+(δH)²
wherein δ is from about 16.4 MPa^{1/2} to about 18.2 MPa^{1/2}, δD is from about 15 MPa^{1/2} to about 18.2 MPa^{1/2}, δP is from greater than 4 MPa^{1/2} to about 6 MPa^{1/2}, and 8H is from about 0 MPa^{1/2} to about 6 MPa^{1/2}.

Embodiment 66: The slurry of embodiment 65, wherein δP is from about 4 MPa^{1/2} to about 5 MPa^{1/2}.

Embodiment 67: The slurry of any one of embodiments 39-66, wherein R₂ comprises an acyclic linear or branched hydrocarbon chain having from five carbon atoms up to twenty carbon atoms.

Embodiment 68: The slurry of any one of embodiments 39-67, wherein R₂ comprises an acyclic linear or branched hydrocarbon chain having from five carbon atoms up to 10 carbon atoms.

Embodiment 69: The slurry of any one of embodiments 39-68, wherein R₂ comprises an acyclic, linear hydrocarbon chain containing five carbon atoms.

Embodiment 70: An electrochemical cell layer for use in an electrochemical cell prepared by casting and drying the slurry of any one of embodiments 1-9 or 20-69.

Embodiment 71: The electrochemical cell layer of embodiment 70, wherein the electrochemical cell layer has a toughness of about 1,000 kPa or greater.

Embodiment 72: The electrochemical cell layer of embodiment 70 or 71, wherein the electrochemical cell layer has an elongation at break from about 10% to about 30%.

Embodiment 73: The electrochemical cell layer of any one of embodiments 70-72, wherein the electrochemical cell layer has an ionic conductivity of about 0.15 mS or greater.

Embodiment 74: An electrochemical cell layer comprising:
a solid-state electrolyte material;
a high molecular weight binder; and
a low molecular weight binder.

Embodiment 75: The electrochemical cell layer of embodiment 74, wherein the electrochemical cell layer has a toughness of about 1,000 kPa or greater.

Embodiment 76: The electrochemical cell layer of embodiment 74 or 75, wherein the electrochemical cell layer, when stretched along a length axis of the separator layer, has an elongation at break from about 10% to about 30%.

Embodiment 77: The electrochemical cell layer of any one of embodiments 74-76, wherein the electrochemical cell layer has an ionic conductivity of about 0.15 mS or greater.

Embodiment 78: The electrochemical cell layer of any one of embodiments 74-77, further comprising an electrode active material.

Embodiment 79: The electrochemical cell layer of any one of embodiments 74-78, further comprising a conductive additive.

### Examples

### Formation and Testing of a Separator Slurry

In each of Examples 1-4 described below, one or more binders were mixed with a single solvent or a blend of solvents at a concentration between 7-15 wt %. The binder(s) were allowed to dissolve in the solvent(s) for 24-48 hours forming a clear binder solution. After this time, the binder solution was mixed with a sulfide-based solid electrolyte material at a ratio to produce a separator slurry containing 30%-50% solids by weight. The separator slurry was mixed in a planetary mixer with media to increase homogenization.

To test the Flow Point of the Separator Slurry, a Parallel Plate Rheometer with a gap of 0.2 mm and a temperature of 20° C. was used. The Flow Point was calculated by locating the point on the amplitude sweep (performed at 1 hz) where the storage modulus (G′) is equal to the loss modulus (G″). Each of the examples are summarized in Tables 1A and 1B below.

TABLE 1A

| | | | | Hanson Solubility | | | Hydro- |
|---|---|---|---|---|---|---|---|
| | Hydro- | | | Parameters | | | carbon:Ester |
| | carbon | R₁ | R₂ | δD | δP | δH | Ratio (volume) |
| Example 1 | Xylenes | — | — | — | — | — | 100:0 |
| Example 2 | Xylenes | — | — | — | — | — | 100:0 |
| Example 3 | Xylenes | 2 | 5 | 15.8 | 5.2 | 5.6 | 98:2 |
| Example 4 | Xylenes | 2 | 5 | 15.8 | 5.2 | 5.6 | 80:20 |
| Example 5 | Xylenes | 2 | 5 | 15.8 | 5.2 | 5.6 | 40:60 |

TABLE 1B

| | Binder with | Binder with | Binder MW Ratio | Flow |
|---|---|---|---|---|
| | MW ≤ 100K | MW ≥ 300K | (≤100K:≥300K) | Point |
| | (wt %) | (wt %) | (by weight) | (Pa) |
| Example 1 | 15 | — | — | 12.12 |
| Example 2 | 5 | 10 | 1:2 | 29.32 |
| Example 3 | 5 | 10 | 1:2 | 1.04 |
| Example 4 | 5 | 10 | 1:2 | 1.15 |
| Example 5 | 5 | 10 | 1:2 | 389 |

### Example 1

A Styrene-Ethylene-Butadiene-Styrene (SEBS) binder having a molecular weight (MW) of less than 100,000 was dissolved in xylenes. To this solution, a solid electrolyte material Li₆PS₅Cl in the form of a powder was added, forming a separator slurry with a solids loading of around 40 wt % with a binder content of 15 wt % (dry basis). This separator slurry was placed in a planetary mixer to homogenize. After homogenization, the separator slurry was placed in a Parallel Plate Rheometer and the Flow Point of this slurry was measured to be 12.12 Pa.

### Example 2

The slurry of Example 2 was formed in the same manner as in Example 1 except two thirds (⅔) of the binder was replaced with a Styrene-Ethylene-Butadiene-Styrene (SEBS) binder having a molecular weight (MW) of greater than 300,000. The ratio of binders in the slurry was 1:2 low molecular weight to high molecular weight. The Flow Point this this slurry was measured to be 29.32 Pa.

### Example 3

The slurry of Example 3 was formed in the same manner as in Example 2 except pure xylenes was replaced with a blend of Xylenes and Amyl Propionate at a volume ratio of 98:2. The Flow Point of this this slurry was measured to be 1.04 Pa.

### Example 4

The slurry of Example 4 was formed in the same manner as in Example 3 except the blend of Xylenes and Amyl Propionate was changed from a volume ratio of 98:2 to a volume ratio of 80:20. The Flow Point of this slurry was measured to be 1.15 Pa.

### Example 5

The slurry of Example 5 was formed in the same manner as in Example 3 except the blend of Xylenes and Amyl Propionate was changed from a volume ratio of 98:2 to a volume ratio of 40:60. The Flow Point of this slurry was measured to be 389 Pa.

### Summary of Results for Examples 1-5

In Example 1 using only xylenes and a low-molecular weight binder, the flow point was 12.12 Pa. In Example 2 using only xylenes and a blend of a low-molecular weight binder and a high-molecular weight binder, the flow point of 29.32 Pa (more than double the flow point of Example 1). Both of these flow points are considered too high for wet slurry processing.

In Example 3, a small amount (2%) of ester solvent was added to the xylene solvent with the same blend of a low-molecular weight binder and a high-molecular weight binder used in Example 2. The flow point was 1.04, which is 28 times lower (or about 96.5% lower) than the flow point of the slurry made in Example 2. This allows for slurries with a high binder content to be processed.

In Example 4, the amount of ester solvent was increased to 10%. The flow point here was 1.15 Pa, which is slightly increased from the flow point in Example 3, but still significantly lower than the flow point of Examples 1 and 2 which did not include an ester solvent. This suggests that addition of the ester solvent allows for flow point control in the slurry.

In Example 5, using a large amount of ester solvent greatly increased the flow point of the slurry.

### Separator Layer Formation and Mechanical Testing

A separator slurry made as described in the previous examples above was cast onto a 20 micron corona-treated Aluminum foil using a doctor blade. The cast slurries were then dried in ambient dry-room conditions until visibly dried, then placed into a vacuum oven. The cast was heated to 80° C. for about 2 hours under active vacuum conditions, and was allowed to cool to ambient temperature while still under active vacuum for about 12 hours.

The free-standing separator was prepared by placing a first dried separator layer against a second dried separator layer, laminated using calendar rollers, and removing one aluminum backing foil. This resulted in a 30 μm thick separator layer. Two double-laminated separators were then laminated together. After lamination, the aluminum foils were removed, resulting in a 60 μm thick free-standing separator. The 60 μm thick free-standing separator layer was then cut into strips 10 mm wide and 20 mm long. These strips were used in Dynamic Mechanical Analysis (DMA) tests, which were performed using an Anton Parr 902 Rheometer.

The experimental parameters are shown in Tables 2A and 2B below.

TABLE 2A

| | | | | Hanson Solubility | | | Hydro- |
|---|---|---|---|---|---|---|---|
| | Hydro- | | | Parameters | | | carbon:Ester |
| | carbon | R₁ | R₂ | δD | δP | δH | Ratio (volume) |
| Example 6 | — | 3 | 3 | 15.1 | 2.8 | 5.8 | 0:100 |
| Example 7 | Xylenes | 2 | 5 | 15.8 | 5.2 | 5.6 | 25:75 |
| Example 8 | Xylenes | 2 | 5 | 15.8 | 5.2 | 5.6 | 25:75 |
| Example 9 | Xylenes | 3 | 3 | 15.1 | 2.8 | 5.8 | 40:60 |
| Example 10 | Xylenes | 2 | 5 | 15.8 | 5.2 | 5.6 | 40:60 |
| Example 11 | Xylenes | 2 | 5 | 15.8 | 5.2 | 5.6 | 25:75 |

TABLE 2B

| | Binder with | Binder with | Binder MW Ratio | | |
|---|---|---|---|---|---|
| | MW ≤ 100K | MW ≥ 300K | (≤100K:≥300K) | Extensional | Extensional |
| | (wt %) | (wt %) | (by weight) | Stress (MPa) | Strain (%) |
| Example 6 | 9 | — | — | 3.2 | 0.6 |
| Example 7 | 15 | — | — | 5.6 | 0.9 |
| Example 8 | 18 | — | — | 7.1 | 1.2 |
| Example 9 | — | 20 | — | 3.5 | 20 |
| Example 10 | 5 | 10 | 1:2 | 4 | 22.5 |
| Example 11 | 11.25 | 3.75 | 3:1 | 4.8 | 40 |

### Example 6

A Styrene-Ethylene-Butadiene-Styrene (SEBS) binder having a molecular weight (MW) of less than 100,000 was dissolved in isobutyl isobutyrate. To this solution, a solid electrolyte material Li₆PS₅Cl in the form of a powder was added, forming a separator slurry with a solids loading of around 40 wt % and a binder content of 9 wt %. This separator slurry was placed in a planetary mixer with media to homogenize the slurry. The separator slurry was cast onto a 20 micron corona-treated aluminum foil using a doctor blade. DMA tests were performed using an Anton Parr 902 Rheometer. The free-standing separator had an extensional stress of 3.2 MPa and an extensional strain of 0.6%.

### Example 7

A Styrene-Ethylene-Butadiene-Styrene (SEBS) binder having a molecular weight (MW) of less than 100,000 was dissolved in a blend of xylenes and amyl propionate having a volume ratio of 25:75 xylenes:amyl propionate. To this solution, a solid electrolyte material Li₆PS₅Cl in the form of a powder was added, forming a separator slurry with a solids loading of around 40 wt % and a binder content of 15 wt %. This separator slurry was placed in a planetary mixer to homogenize the slurry. The separator layer and stress and strain testing of Example 7 were conducted in the same manner as in Example 6. The free-standing separator had an extensional stress of 5.6 MPa and an extensional strain of 0.9%.

### Example 8

The slurry formation of Example 8 was conducted in the same manner as in Example 7 except the binder content was increased from 15 wt % to 18 wt %. The separator layer and stress and strain testing of Example 8 were conducted in the same manner as in Example 6. The free-standing separator of Example 8 had an extensional stress of 7.1 MPa and an extensional strain of 1.2%.

### Example 9

A Styrene-Ethylene-Butadiene-Styrene (SEBS) binder having a molecular weight (MW) of greater than 300,000 was dissolved in a blend of xylenes and isobutyl isobutyrate having a volume ratio of 40:60 xylenes:isobutyl isobutyrate. To this solution, a solid electrolyte material Li₆PS₅Cl in the form of a powder was added, forming a separator slurry with a solids loading of about 40 wt % and a binder content of 20 wt %. This separator slurry was placed in a planetary mixer to homogenize the slurry. The separator layer and stress and strain testing of Example 9 were conducted in the same manner as in Example 6. The free-standing separator of Example 9 had an extensional stress of 3.5 MPa and an extensional strain of 20%.

### Example 10

A Styrene-Ethylene-Butadiene-Styrene (SEBS) binder having a molecular weight (MW) of less than 100,000 and a Styrene-Ethylene-Butadiene-Styrene (SEBS) binder having a molecular weight (MW) of greater than 300,000, at a weight ratio of 1:2 (Low MW:High MW), was dissolved in a blend of xylenes and amyl propionate having a volume ratio of 40:60 xylenes:amyl propionate. To this solution, a solid electrolyte material Li₆PS₅Cl in the form of a powder was added, forming a separator slurry with a solids loading of around 40 wt % and a binder content of 15 wt %. This separator slurry was placed in a planetary mixer to homogenize the slurry. The separator layer and stress and strain testing of Example 10 were conducted in the same manner as in Example 6. The free-standing separator of Example 10 had an extensional stress of 4 MPa and an extensional strain of 22.5%.

### Example 11

A Styrene-Ethylene-Butadiene-Styrene (SEBS) binder having a molecular weight (MW) of less than 100,000 and a Styrene-Ethylene-Butadiene-Styrene (SEBS) binder having a molecular weight (MW) of greater than 300,000, at a weight ratio of 3:1, was dissolved in a blend of xylenes and amyl propionate having a volume ratio of 25:75 xylenes:amyl propionate. To this solution, a solid electrolyte material Li₆PS₅Cl in the form of a powder was added, forming a separator slurry with a solids loading of around 40 wt % and a binder content of about 15 wt %. This separator slurry was placed in a planetary mixer to homogenize the slurry. The separator layer and stress and strain testing of Example 11 were conducted in the same manner as in Example 6. The free-standing separator of Example 11 had an extensional stress of 4.8 MPa and an extensional strain of 40%.

### Summary of Results of Examples 6-11

Example 6, which used only an ester solvent and a low-MW binder, produced a separator layer having low extensional strain and extensional stress. Example 7, which included the addition of xylenes and increased low-MW binder content, increased the extensional strain and extensional stress of the separator layer. Example 8 further increased the low-MW binder concentration as compared with Example 7 and also increased the extensional strain and extensional stress of the separator layer.

In Example 9, a high-MW binder was used instead of a low-MW binder and in a higher concentration than the low-MW binder used in Examples 6-8. Example 9 also included a greater amount of xylenes in the solvent blend. This change increased the extensional strain of the separator layer, but lowered the extensional stress of the separator layer.

In Example 10, using a blend of the ester and hydrocarbon and a blend of the low-MW and high-MW binder, the extensional strain was increased as compared with each of Examples 6-9 and the extensional stress was increased as compared with Examples 5 and 8. Generally, lower binder concentrations in separator layers are preferred to maximize the conductivity of the separator layer. It is noted that as compared with Examples 8 and 9, Example 10 had a lower total concentration of binder(s) and had the same concentration of binder(s) as in Example 7.

In Example 11, using an increased ratio of the low-MW binder to the high-MW binder, the extensional strain was nearly doubled as compared with Examples 9 and 10 and the Extensional Stress was further increased as compared with Example 10. As compared with Example 7 which included the same solvent blend and total binder concentration, the extensional strain increased by over 40 times and the extensional stress decreased by only 0.8 MPa.

Features described above as well as those claimed below may be combined in various ways without departing from the scope hereof. It should thus be noted that the matter contained in the above description or shown in the accompanying drawings should be interpreted as illustrative and not in a limiting sense. The above-described embodiments should be considered as examples of the present invention, rather than as limiting the scope of the invention. In addition to the foregoing embodiments of inventions, review of the detailed description and accompanying drawings will show that there are other embodiments of such inventions. Accordingly, many combinations, permutations, variations and modifications of the foregoing embodiments of inventions not set forth explicitly herein will nevertheless fall within the scope of such inventions. The following claims are intended to cover generic and specific features described herein, as well as all statements of the scope of the present method and system, which, as a matter of language, might be said to fall there between.

What is claimed is:

1. A slurry comprising:
an ester solvent having Hansen Solubility Parameters following the formula:
δ⁻²=(δD)²+(δP)²+(δH)²
wherein:
δ is from about 16.4 MPa^{1/2} to about 18.2 MPa^{1/2},
δD is from about 15 MPa^{1/2} to about 18.2 MPa^{1/2},
δP is from greater than 4 MPa^{1/2} to about 6 MPa^{1/2}, and
δH is from about 0 MPa^{1/2} to about 6 MPa^{1/2}, and
wherein the ester solvent has the formula: 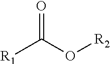
wherein R₁ is H, methyl, ethyl, or propyl, and R₂ is an acyclic linear or branched hydrocarbon chain having five carbon atoms or more;
a hydrocarbon solvent;
a low molecular weight binder having a molecular weight of 100,000 or less; and
a high molecular weight binder having a molecular weight of 300,000 or more.

2. The slurry of claim 1, wherein the hydrocarbon solvent comprises xylene, toluene, benzene, hexane, heptane, octane, or any combination thereof.

3. The slurry of claim 1, wherein the ester solvent comprises 2-ethyl-hexyl acetate.

4. The slurry of claim 1, wherein the ester solvent comprises amyl propionate.

5. The slurry of claim 1, wherein the low molecular weight binder and the high molecular weight binder are the same species of binder with differing polymer chain lengths.

6. The slurry of claim 1, wherein the weight ratio of the high molecular weight binder to the low molecular weight binder is from about 10:90 to about 90:10.

7. The slurry of claim 1, further comprising a solid electrolyte material.

8. The slurry of claim 1, further comprising an electrode active material.

9. The slurry of claim 1, further comprising a conductive additive.

10. An electrochemical cell layer comprising:
a solid-state electrolyte material;
a low molecular weight binder having a molecular weight of 100,000 or less;
a high molecular weight binder wherein the molecular weight is 300,000 or more; and
wherein the weight ratio of the high molecular weight binder to the low molecular weight biner is from about 10:90 to about 90:10.

11. The electrochemical cell layer of claim 10, wherein the low molecular weight binder and the high molecular weight binder are the same species of binder with differing polymer chain lengths.

12. The electrochemical cell layer of claim 10, further comprising an electrode active material.

13. The electrochemical cell layer of claim 10, further comprising a conductive additive.

14. The electrochemical cell layer 10, further comprising an alkali metal carboxylate material having the formula: 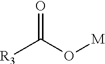
wherein R₃ comprises H, methyl, or ethyl, and
wherein M comprises an alkali metal.

15. The electrochemical cell layer of claim 14, wherein M comprises lithium, sodium, potassium, or a combination thereof.

16. An electrochemical cell comprising:
a cathode layer comprising a cathode active material;
a separator layer comprising a solid electrolyte material, a high molecular weight binder having a molecular weight of 300,000 or more, and a low molecular weight binder having a molecular weight of 100,000 or less, wherein the weight ratio of the high molecular weight binder to the low molecular weight binder is from about 10:90 to about 90:10; and
an anode layer comprising an anode active material.

17. The electrochemical cell of claim 16, wherein the low molecular weight binder and the high molecular weight binder are the same species of binder with differing polymer chain lengths.

18. The electrochemical cell of claim 16, wherein the cathode layer further comprises:
a high molecular weight binder, wherein the molecular weight is 300,000 or more, and
a low molecular weight binder wherein the molecular weight is 100,000 or less,
wherein the weight ratio of the high molecular weight binder to the low molecular weight binder is from about 10:90 to about 90:10.

19. The electrochemical cell of claim 16, wherein the electrode layer comprising a cathode active material further comprises an alkali metal carboxylate material having the formula: 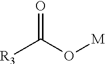
wherein R₃ comprises H, methyl, or ethyl, and
wherein M comprises an alkali metal.

20. A slurry comprising:
an ester solvent, the ester solvent having the formula: 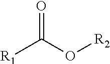
wherein R₁ is H, methyl, ethyl, or propyl, and R₂ is an acyclic linear or branched hydrocarbon chain having five carbon atoms or more;
a hydrocarbon solvent; and
a binder.
